(19) United States
(12) Patent Application Publication
(10) Pub. No.: US 2026/0058775 A1
(43) Pub. Date: Feb. 26, 2026

(54) DEMODULATION REFERENCE SIGNAL PATTERN

(71) Applicant: QUALCOMM Incorporated, San Diego, CA (US)

(72) Inventors: Somsubhra BARIK, San Diego, CA (US); Jing SUN, San Diego, CA (US); Chih-Hao LIU, San Diego, CA (US)

(21) Appl. No.: 18/814,684

(22) Filed: Aug. 26, 2024

(51) Int. Cl. H04L 5/00; H04W 72/0446; H04W 72/51

(52) U.S. Cl. CPC H04L 5/0051; H04W 72/0446; H04W 72/51

(57) ABSTRACT

Various aspects of the present disclosure generally relate to wireless communication. In some aspects, a user equipment (UE) may receive a configuration indicating a time domain spacing pattern information for a demodulation reference signal (DMRS), the time domain spacing pattern information indicating a time domain spacing parameter and a time domain offset parameter. The UE may receive a start and length indicator value (SLIV) indicating a time domain resource allocation associated with a channel. The UE may communicate, during the time domain resource allocation, one or more DMRSs associated with the channel at respective time domain locations that are based at least in part on the SLIV and the time domain spacing pattern information. Numerous other aspects are described.

### FIELD OF THE DISCLOSURE

Aspects of the present disclosure generally relate to wireless communication and specifically relate to techniques, apparatuses, and methods for a demodulation reference signal pattern.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to receive a configuration indicating a time domain spacing pattern information for a demodulation reference signal (DMRS), the time domain spacing pattern information indicating a time domain spacing parameter and a time domain offset parameter. The one or more processors may be configured to receive a start and length indicator value (SLIV) indicating a time domain resource allocation associated with a channel. The one or more processors may be configured to communicate, during the time domain resource allocation, one or more DMRSs associated with the channel at respective time domain locations that are based at least in part on the SLIV and the time domain spacing pattern information.

Some aspects described herein relate to a network node for wireless communication. The network node may include one or more memories and one or more processors coupled to the one or more memories. The one or more processors may be configured to transmit, for a UE, a configuration indicating a time domain spacing pattern information for a DMRS, the time domain spacing pattern information indicating a time domain spacing parameter and a time domain offset parameter. The one or more processors may be configured to transmit, for the UE, an SLIV indicating a time domain resource allocation associated with a channel. The one or more processors may be configured to communicate, for the UE and during the time domain resource allocation, one or more DMRSs associated with the channel at respective time domain locations that are based at least in part on the SLIV and the time domain spacing pattern information.

Some aspects described herein relate to a method of wireless communication performed by a UE. The method may include receiving a configuration indicating a time domain spacing pattern information for a DMRS, the time domain spacing pattern information indicating a time domain spacing parameter and a time domain offset parameter. The method may include receiving an SLIV indicating a time domain resource allocation associated with a channel. The method may include communicating, during the time domain resource allocation, one or more DMRSs associated with the channel at respective time domain locations that are based at least in part on the SLIV and the time domain spacing pattern information.

Some aspects described herein relate to a method of wireless communication performed by a network node. The method may include transmitting, for a UE, a configuration indicating a time domain spacing pattern information for a DMRS, the time domain spacing pattern information indicating a time domain spacing parameter and a time domain offset parameter. The method may include transmitting, for the UE, an SLIV indicating a time domain resource allocation associated with a channel. The method may include communicating, for the UE and during the time domain resource allocation, one or more DMRSs associated with the channel at respective time domain locations that are based at least in part on the SLIV and the time domain spacing pattern information.

Some aspects described herein relate to a non-transitory computer-readable medium that stores a set of instructions for wireless communication by a UE. The set of instructions, when executed by one or more processors of the UE, may cause the UE to receive a configuration indicating a time domain spacing pattern information for a DMRS, the time domain spacing pattern information indicating a time domain spacing parameter and a time domain offset parameter. The set of instructions, when executed by one or more processors of the UE, may cause the UE to receive an SLIV indicating a time domain resource allocation associated with a channel. The set of instructions, when executed by one or more processors of the UE, may cause the UE to communicate, during the time domain resource allocation, one or more DMRSs associated with the channel at respective time domain locations that are based at least in part on the SLIV and the time domain spacing pattern information.

Some aspects described herein relate to a non-transitory computer-readable medium that stores a set of instructions for wireless communication by a network node. The set of instructions, when executed by one or more processors of the network node, may cause the network node to transmit, for a UE, a configuration indicating a time domain spacing pattern information for a DMRS, the time domain spacing pattern information indicating a time domain spacing parameter and a time domain offset parameter. The set of instructions, when executed by one or more processors of the network node, may cause the network node to transmit, for the UE, an SLIV indicating a time domain resource allocation associated with a channel. The set of instructions, when executed by one or more processors of the network node, may cause the network node to communicate, for the UE and during the time domain resource allocation, one or more DMRSs associated with the channel at respective time domain locations that are based at least in part on the SLIV and the time domain spacing pattern information.

Some aspects described herein relate to an apparatus for wireless communication. The apparatus may include means for receiving a configuration indicating a time domain spacing pattern information for a DMRS, the time domain spacing pattern information indicating a time domain spacing parameter and a time domain offset parameter. The apparatus may include means for receiving an SLIV indicating a time domain resource allocation associated with a channel. The apparatus may include means for communicating, during the time domain resource allocation, one or more DMRSs associated with the channel at respective time domain locations that are based at least in part on the SLIV and the time domain spacing pattern information.

Some aspects described herein relate to a first apparatus for wireless communication. The first apparatus may include means for transmitting, for a second apparatus, a configuration indicating a time domain spacing pattern information for a DMRS, the time domain spacing pattern information indicating a time domain spacing parameter and a time domain offset parameter. The first apparatus may include means for transmitting, for the second apparatus, an SLIV indicating a time domain resource allocation associated with a channel. The first apparatus may include means for communicating, for the UE and during the time domain resource allocation, one or more DMRSs associated with the channel at respective time domain locations that are based at least in part on the SLIV and the time domain spacing pattern information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of time domain resource allocations, in accordance with the present disclosure.

FIG. 5 is a diagram illustrating an example of channel estimation, in accordance with the present disclosure.

FIG. 6 is a diagram of an example associated with signaling for a demodulation reference signal (DMRS) pattern, in accordance with the present disclosure.

FIG. 7 is a diagram of an example associated with a DMRS pattern, in accordance with the present disclosure.

FIG. 8 is a diagram of an example associated with DMRS instance spacing a DMRS pattern, in accordance with the present disclosure.

FIG. 9 is a diagram of an example associated with a DMRS pattern, in accordance with the present disclosure.

FIG. 10 is a diagram of an example associated with a DMRS pattern, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A demodulation reference signal (DMRS) may carry information used to estimate a radio channel for demodulation of an associated physical channel. The design and mapping of a DMRS may be specific to a physical channel for which the DMRS is used for estimation. DMRSs are user equipment (UE)-specific, can be beamformed, can be confined in a scheduled resource (e.g., rather than transmitted on a wideband), and can be transmitted only when necessary. DMRSs are used for both downlink communications and uplink communications.

A pattern of DMRSs (or DMRS instances) may be indicated via one or more configuration parameters (e.g., radio resource control (RRC) parameters or other parameters). For example, a DMRS configuration (e.g., DMRS-downlinkConfig for downlink DMRS configuration or DMRS-uplinkConfig for uplink DMRS configuration) may indicate DMRS position(s) within a slot. As an example, the DMRS configuration may indicate a DMRS mapping type, such as a DMRS Type A and a DMRS Type B. The DMRS mapping type may be indicative of a first OFDM symbol within a slot that includes a DMRS (e.g., for DMRS mapping Type A, a first DMRS within a slot may be included in symbol 2 or symbol 3 within the slot, and for DMRS mapping Type B, the DMRS starts at the first symbol of a time domain resource allocation (TDRA) for a physical channel (e.g., indicated by a start and length indicator value (SLIV) as described elsewhere herein)). The DMRS configuration may indicate additional DMRS positions within a slot using an additional position parameter (e.g., a dmrs-AdditionalPosition parameter). The additional position parameter may indicate one or more additional DMRS positions within a slot (e.g., where the positions are indicated relative to a start of the slot).

To ensure that a DMRS is transmitted for a physical channel, the DMRS may be configured within the TDRA for the physical channel. As an example, because the DMRS mapping Type A can only start at symbol 2 or symbol 3 within a slot, a TDRA that starts at symbol 4 or later within the slot cannot use DMRSs configured with the DMRS mapping Type A. Therefore, synchronization between the DMRS configuration or pattern and the TDRA for a physical channel ensures that the DMRS(s) are transmitted in connection with the physical channel, thereby enabling a receiver to perform channel estimation for the physical channel using the DMRS(s). As described above, DMRS configurations and/or patterns may be indicated relative to a slot structure or frame structure for a cell (e.g., the additional position parameter may indicate one or more additional DMRS positions and/or some DMRS mapping types may indicate DMRS positions relative to the slot structure). However, as described above, some TDRAs may be indicated by an SLIV that can span multiple slots. In such examples, the SLIV may be indicated independent of a slot structure configured for the cell (e.g., the SLIV may start or end at any point in time, rather than being confined to a single slot). Therefore, the DMRS configurations and/or patterns that rely on the fixed slot structure may not be suitable for TDRAs and/or SLIVs that can span multiple slots. For example, such DMRS configurations and/or patterns may result in a DMRS not being configured within a TDRA for the physical channel, or too few DMRSs being configured within the TDRA, thereby degrading channel estimation performance performed by a receiver using the DMRS(s). As another example, such DMRS configurations and/or patterns may result in more DMRSs than are needed for channel estimation being configured within a TDRA for the physical channel, thereby consuming network resources associated with communicating the DMRSs.

Various aspects relate generally to a DMRS pattern. Some aspects more specifically relate to a DMRS pattern or configuration for an SLIV that is associated with indicating a TDRA that spans multiple slots or that is not limited to being contained within a single slot (e.g., sometimes referred to as a fluid SLIV). In some aspects, a DMRS configuration may indicate time domain spacing pattern information for DMRSs. The time domain spacing pattern information may indicate a time domain spacing parameter and/or a time domain offset parameter, among other examples. The time domain spacing parameter may be indicative of a spacing (e.g., in the time domain) between DMRS instances within a TDRA for a physical channel (e.g., indicated by a fluid SLIV). As used herein, “DMRS instance” refers to a time domain resource in which a DMRS is communicated (e.g., transmitted and/or received). A DMRS instance may include one or more symbols (sometimes referred to as DMRS symbols) in which a DMRS is configured.

The time domain spacing parameter may indicate one or more time gaps between DMRS instances included in the TDRA. Therefore, the quantity of DMRS instances that are included in a given TDRA may be based on, or otherwise associated with, the time domain spacing parameter and a size of the given TDRA (e.g., as indicated by the SLIV which may be indicated via control information). In some aspects, the time domain spacing parameter may indicate a uniform or equal spacing between DMRS instances. In other aspects, the time domain spacing parameter may indicate a non-uniform or unequal spacing between DMRS instances. As an example, the time domain spacing pattern information may indicate the time domain spacing parameter (e.g., indicating one or more inter-DMRS intervals) and one or more parameters indicating whether additional DMRS instances are to be included within some (or all) inter-DMRS intervals. As another example, the time domain spacing pattern information may indicate a sequence of time domain spacing parameters indicating multiple inter-DMRS interval spacings for a given TDRA.

The time domain offset parameter may indicate a time domain position of a first DMRS instance within a TDRA. For example, the time domain offset parameter may indicate an offset relative to the start of the TDRA (e.g., as indicated by the SLIV) indicative of a first symbol in which a DMRS is configured. In some examples, the offset may be a value greater than zero (e.g., in terms of a quantity of symbols). As another example, the time domain offset parameter may indicate a time domain position of a first DMRS instance within a TDRA relative to the start of a first slot included in the TDRA.

In some aspects, the time domain spacing pattern information may be indicated via multiple communications. For example, an RRC communication may indicate first information for the time domain spacing parameter and a control communication (e.g., downlink control information (DCI) or other control information) may indicate second information for the time domain spacing parameter. The time domain spacing parameter may be based on the first information and the second information.

Particular aspects of the subject matter described in this disclosure can be implemented to realize one or more of the following potential advantages. In some examples, by a network node configuring a DMRS pattern using the time domain spacing pattern information described herein, the described techniques can be used to improve a likelihood that an appropriate quantity of and/or spacing between DMRS instances is configured within a TDRA that is not bound, limited, or confined to a single slot. This increases scheduling flexibility by enabling a TDRA to be indicated via an SLIV that is not limited to indicating time domain resources within a single slot (e.g., and can span multiple slots in some cases) while ensuring that there is an appropriate and/or synchronized DMRS configuration for the TDRA. This improves channel estimation performance for the TDRA using DMRS(s) indicated by the DMRS pattern.

In some aspects, by the network node configuring the DMRS pattern using the time domain spacing parameter, a time domain spacing between DMRS instances can be configured for different TDRAs (e.g., that are not confined or limited to be included within a single slot), thereby improving scheduling flexibility while also ensuring that each TDRA includes DMRS instances that are spaced as indicated by the time domain spacing parameter. In some aspects, by the network node configuring the DMRS pattern using the time domain spacing parameter that indicates a non-uniform or unequal time domain spacing between DMRS instances, the network node can configure more DMRS instances to occur during a portion of a TDRA that may be more robust for channel estimates (e.g., channel estimates earlier in a TDRA may be more robust). In some aspects, by the network node indicating the time domain spacing pattern information via multiple communications (e.g., an RRC communication and a DCI communication), an RRC signaling overhead for configuring the DMRS pattern may be reduced and/or the network node may have additional flexibility to modify or adapt the DMRS pattern to changing channel conditions or operating conditions (e.g., because RRC re-configurations may be associated with increased latency as compared to changing or modifying a parameter via a DCI communication).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

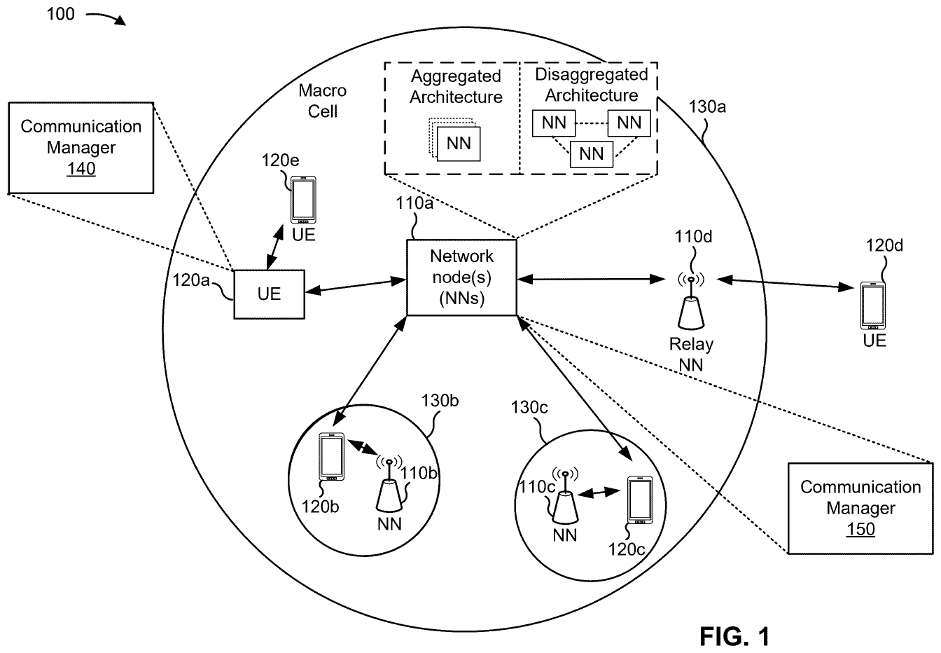

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a configuration indicating a time domain spacing pattern information for a DMRS, the time domain spacing pattern information indicating a time domain spacing parameter and a time domain offset parameter; receive an SLIV indicating a time domain resource allocation associated with a channel; and communicate, during the time domain resource allocation, one or more DMRSs associated with the channel at respective time domain locations that are based at least in part on the SLIV and the time domain spacing pattern information. Additionally, or alternatively, the communication manager 140 may perform one or more other operations described herein.

In some aspects, the network node 110 may include a communication manager 150. As described in more detail elsewhere herein, the communication manager 150 may transmit, for a UE, a configuration indicating a time domain spacing pattern information for a DMRS, the time domain spacing pattern information indicating a time domain spacing parameter and a time domain offset parameter; transmit, for the UE, an SLIV indicating a time domain resource allocation associated with a channel; and communicate, for the UE and during the time domain resource allocation, one or more DMRSs associated with the channel at respective time domain locations that are based at least in part on the SLIV and the time domain spacing pattern information. Additionally, or alternatively, the communication manager 150 may perform one or more other operations described herein.

As indicated above, FIG. 1 is provided as an example. Other examples may differ from what is described with regard to FIG. 1.

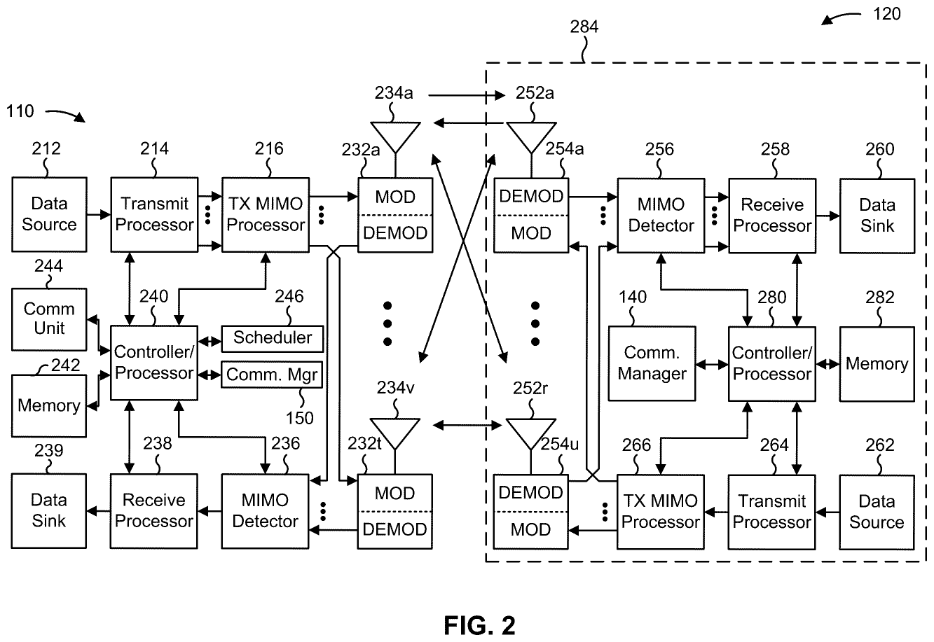

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

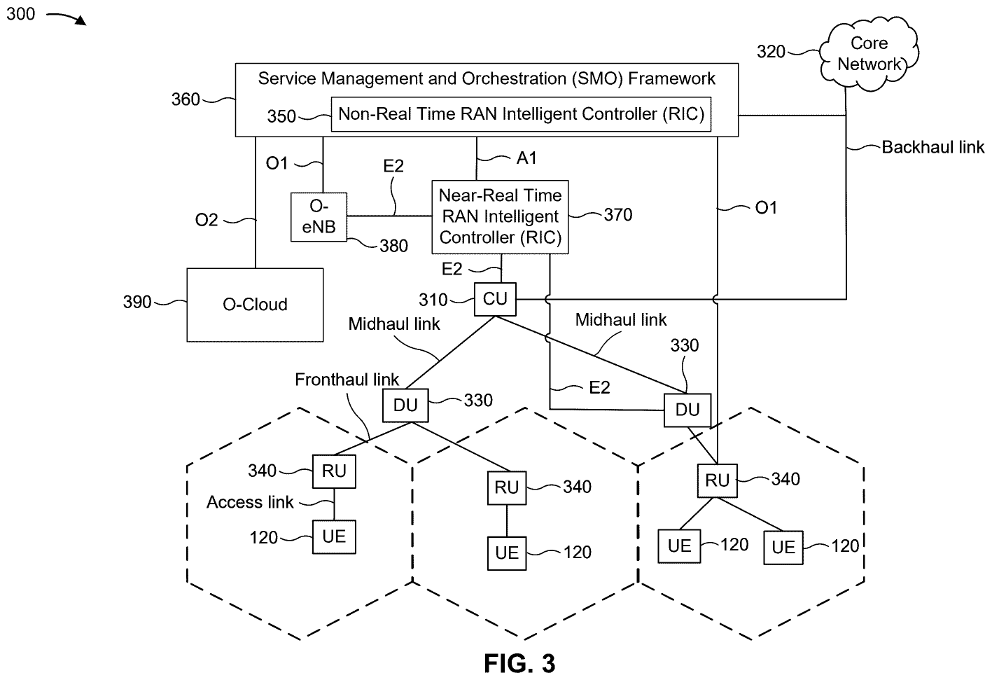

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

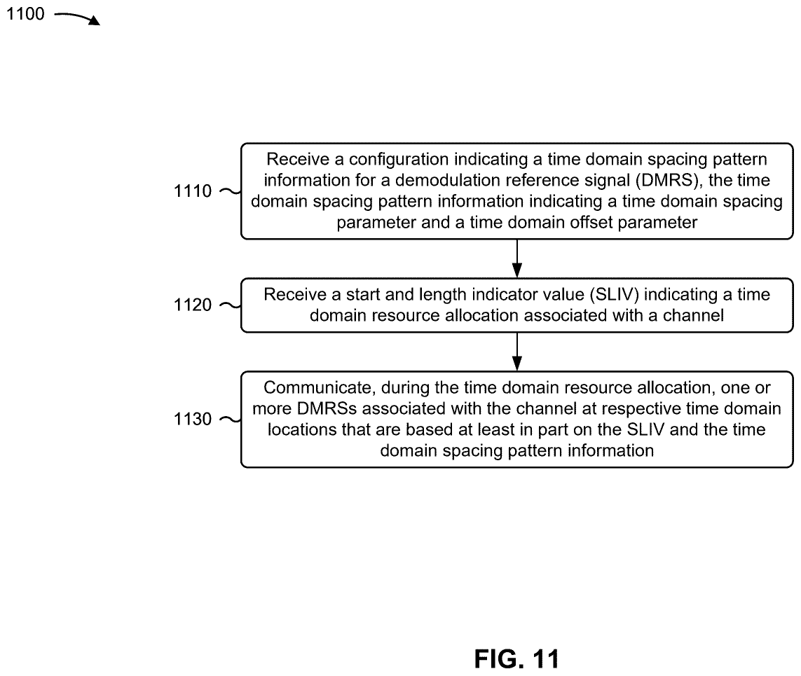

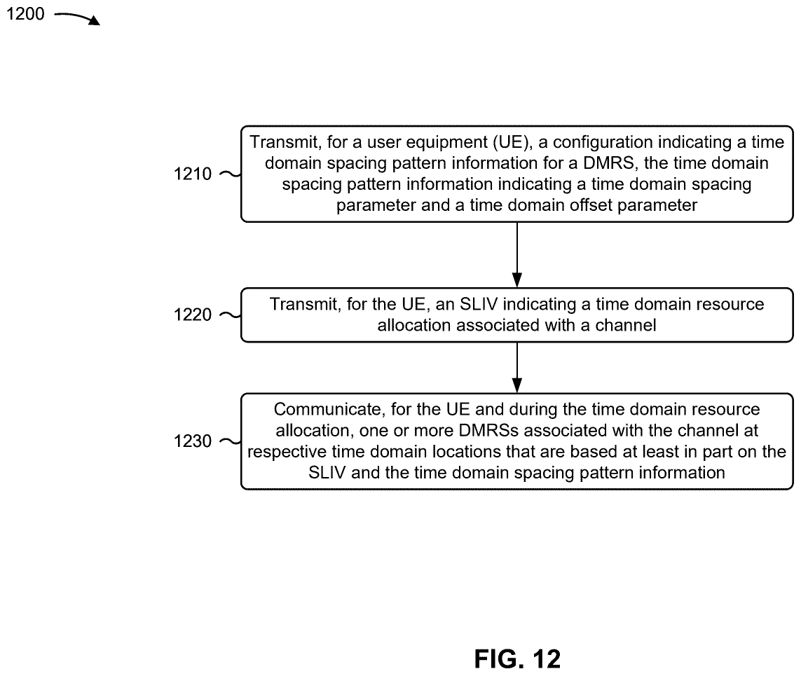

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a DMRS pattern, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving a configuration indicating a time domain spacing pattern information for a DMRS, the time domain spacing pattern information indicating a time domain spacing parameter and a time domain offset parameter; means for receiving an SLIV indicating a time domain resource allocation associated with a channel; and/or means for communicating, during the time domain resource allocation, one or more DMRSs associated with the channel at respective time domain locations that are based at least in part on the SLIV and the time domain spacing pattern information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, for a UE, a configuration indicating a time domain spacing pattern information for a DMRS, the time domain spacing pattern information indicating a time domain spacing parameter and a time domain offset parameter; means for transmitting, for the UE, an SLIV indicating a time domain resource allocation associated with a channel; and/or means for communicating, for the UE and during the time domain resource allocation, one or more DMRSs associated with the channel at respective time domain locations that are based at least in part on the SLIV and the time domain spacing pattern information. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As used herein, the network node 110 “outputting” or “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU outputting or transmitting a communication to an RU and the RU transmitting the communication to the UE 120, or may include causing the RU to transmit the communication (e.g., triggering transmission of a physical layer reference signal). Similarly, the UE 120 “outputting” or “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU. Similarly, the network node 110 “obtaining” a communication may refer to receiving a transmission carrying the communication directly (for example, from the UE 120 to the network node 110) or receiving the communication (or information derived from reception of the communication) via one or more other network nodes or devices.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU).

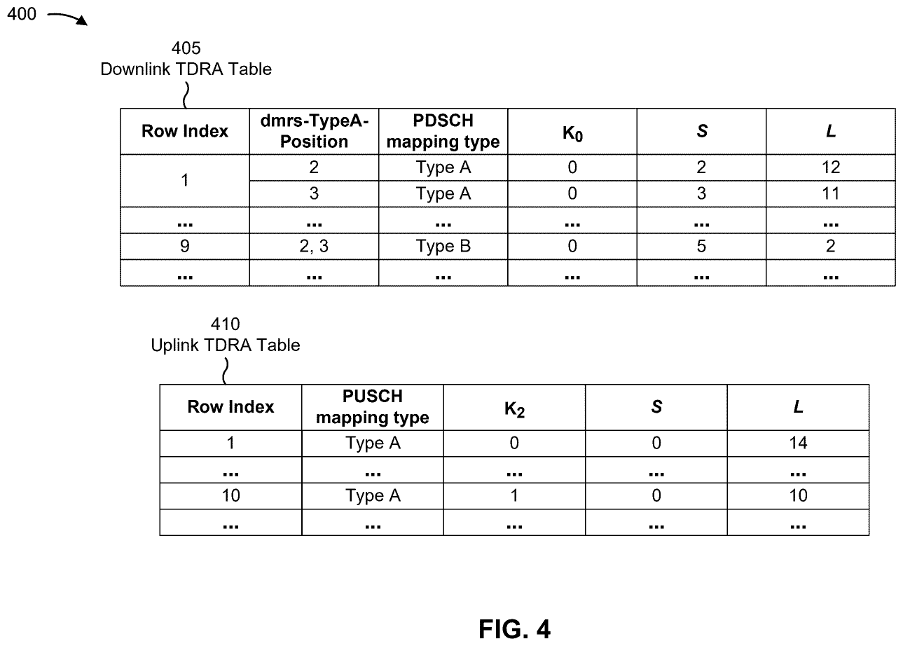

FIG. 4 is a diagram illustrating an example 400 of time domain resource allocations, in accordance with the present disclosure. FIG. 4 shows an example downlink time domain resource allocation (TDRA) table 405 and an example uplink TDRA table 410. The downlink TDRA table 405 may be, for example, a PDSCH TDRA table. The uplink TDRA table 410 may be, for example, a PUSCH TDRA table. In some aspects, the network node 110 and the UE 120 may use different TDRA tables than those shown in FIG. 4, such as for different configurations, different cells, and/or different sub-carrier spacings of cells.

The transmission timeline for each of the downlink and uplink may be partitioned into units of radio frames (sometimes referred to as frames). Each radio frame may have a predetermined duration (e.g., 10 milliseconds (ms)) and may be partitioned into a set of one or more subframes (e.g., with indices of 0 through Z−1). Each subframe may have a predetermined duration (e.g., 1 ms) and may include a set of one or more slots (e.g., 2n slots per subframe, where n is an index of a numerology used for a transmission, such as 0, 1, 2, 3, 4, or another number). Each slot may include a set of L symbol periods. For example, each slot may include fourteen symbol periods, seven symbol periods, or another number of symbol periods. In an example where a subframe includes two slots, the subframe may include 2L symbol periods, where the 2L symbol periods in each subframe may be assigned indices of 0 through 2L−1. In some examples, a scheduling unit may be frame-based, subframe-based, slot-based, mini-slot based, or symbol-based.

When scheduling a communication, a network node 110 may transmit downlink control information (DCI) that indicates a TDRA for the communication. The TDRA may indicate a symbol-based scheduling unit (e.g., may schedule a TDRA in terms of a quantity of symbols). For example, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The network node 110 and the UE 120 may use those TDRA parameters for scheduled communications. In the examples shown in FIG. 4, a TDRA index value of m in the DCI may correspond to a row index of m+1 in the TDRA table. For example, a TDRA index value of 0 may correspond to a row index of 1.

For a downlink communication (e.g., a PDSCH communication), the TDRA parameters may include, for example, a K0 value, an S value, and an L value. The K0 value may represent a scheduling offset (e.g., in number of slots) between the slot containing the scheduling DCI (that schedules the downlink communication) and the slot containing the scheduled downlink communication (scheduled by the scheduling DCI). The S value may represent a starting symbol for the downlink communication in the indicated slot. The L value may represent a length (e.g., a number of consecutive symbols) of the downlink communication (e.g., in the indicated slot). In some aspects, the same row index value may correspond to a different set of TDRA parameters depending on a Type A demodulation reference signal (DMRS) position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used). The DMRS type (e.g., Type A DMRS position) may be indicated via a semi-static parameter (e.g., a dmrs-TypeA-Position parameter), such as via RRC signaling or system information signaling (e.g., in a master information block (MIB) or system information block (SIB)). Other TDRA parameters may be indicated via physical layer signaling (e.g., may be carried via DCI). For example, a TDRA index carried by DCI, in combination with one or more other semi-static parameters (e.g., dmrs-TypeA-Position) may indicate a row of a TDRA table.

For an uplink communication (e.g., a PUSCH communication), the TDRA parameters may include, for example, a K2 value, an S value, and an L value. The K2 value may represent a scheduling offset (e.g., in number of slots) between the slot containing the scheduling DCI (that schedules the uplink communication) and the slot containing the scheduled uplink communication (scheduled by the scheduling DCI). The S value may represent a starting symbol for the uplink communication in the indicated slot. The L value may represent a length (e.g., a number of consecutive symbols) of the uplink communication (e.g., in the indicated slot). In some aspects, the same row index value may correspond to a different set of TDRA parameters depending on, for example, an uplink mapping type (e.g., indicating a starting symbol of the DMRS, a length of the DMRS, and/or whether slot-based scheduling or mini-slot-based scheduling is used).

In some examples, an S value and an L value for a TDRA may be indicated or configured by a single value. The single value may be referred to as an SLIV. The SLIV may be indicated via configuration information, such as an RRC parameter. For example, a time domain allocation for a channel may be configured via an RRC information element (IE) (e.g., PDSCH-TimeDomainResourceAllocation IE for the PDSCH or PUSCH-TimeDomainResourceAllocation IE for the PUSCH). The RRC IE may include a field for indicating the SLIV. The field may be a start symbol and length field (e.g., a startSymbolAndLength field) that includes a bit string indicative of the SLIV. The SLIV may be mapped or coded to an S value and an L value based on a set of TDRA parameters (e.g., configured via the RRC IE or another RRC IE) and an equation. The TDRA parameters may include a mapping type (e.g., a PDSCH mapping type or a PUSCH mapping type). The equation may define how an SLIV is calculated using an S value and an L value. The equation may be as follows:

```
if(L − 1) ≤ 7:
    SLIV = 14 × (L − 1) + S
  else:
    SLIV = 14 × (14 − L + 1) + (14 − 1 − S)
```

A wireless communication standard (e.g., the 3GPP) may define, or otherwise fix, valid combinations of S values and L values (e.g., for different mapping types). A UE may derive an S value and an L value from an SLIV using the equation described above, the mapping type, and the valid combinations of S values and L values.

In some examples, an SLIV may indicate a TDRA that is confined to a single slot. For example, the UE may expect that the SLIV indicates a TDRA that is included within a single slot (e.g., that the TDRA does not cross a slot boundary between two different slots). In such examples, to increase or extend the coverage of transmission for a physical channel, multiple TDRAs for respective transmissions (e.g., repeated transmissions) may be allocated in consecutive time domain resources such that the collective time domain resources of the multiple TDRAs may span across multiple slots. In such examples, the repeated transmissions may be different redundancy versions of a transmission. Each TDRA of the multiple TDRAs may not cross a slot boundary (e.g., although the collective time domain resources of the multiple TDRAs may cross a slot boundary).

In other examples, to increase scheduling flexibility and extend the coverage of transmission for a physical channel, an SLIV may indicate a TDRA that is not limited or configured to a single slot and/or that can cross a slot boundary (e.g., to enable a TDRA for a physical channel to span multiple slots). This reduces the complexity that would otherwise be associated with scheduling or allocating multiple TDRAs for respective transmissions to extend the coverage for the physical channel. An SLIV that indicates a TDRA that is not confined to a single slot and/or that crosses a slot boundary may be referred to as a “fluid” SLIV.

As indicated above, FIG. 4 is provided as an example. Other examples may differ from what is described with respect to FIG. 4.

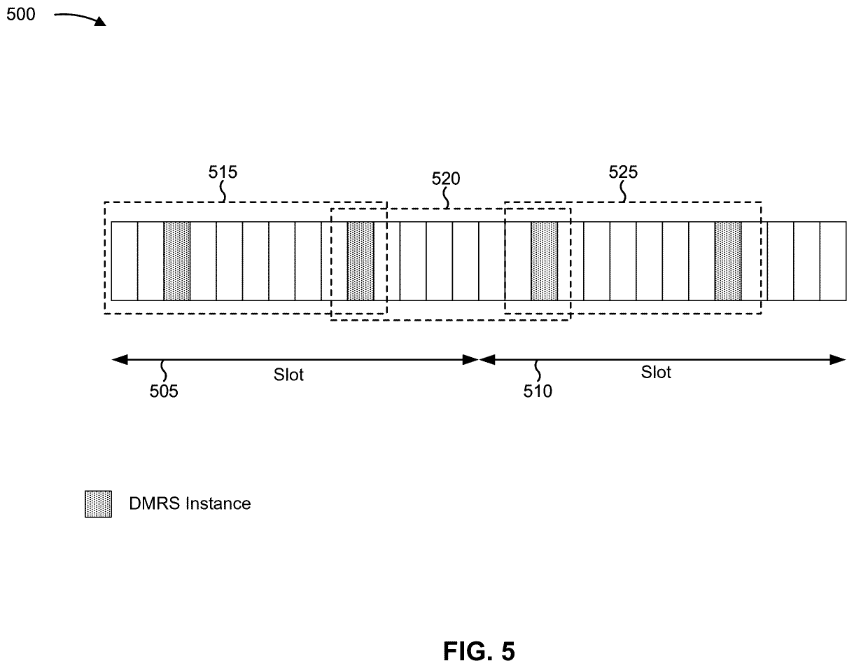

FIG. 5 is a diagram illustrating an example 500 of channel estimation, in accordance with the present disclosure.

In context of example 500, a transmitter (e.g., a UE 120 or a network node 110) and a receiver (e.g., a network node 110 or a UE 120) may communicate with each other. In some examples, the transmitter may transmit, and the receiver may receive, one or more DMRSs. The receiver may perform a channel estimation using the one or more DMRSs. For example, DMRS-based channel estimation may include the receiver detecting one or more DMRSs from a received signal, which may be affected by various channel impairments, such as path loss, multipath fading, and/or noise, among other examples. The receiver may extract the DMRS(s) from the received signal based on the known DMRS pattern (or locations) within the received signal. To perform channel estimation, the receiver may compare the received DMRS(s) with an expected DMRS, using a comparison approach, such as least square (LS) or minimum mean square error (MMSE) estimation. The comparison may be indicative of an estimate of the channel's effect on the received DMRS(s). This estimated channel response, which represents how the signal has been distorted during transmission, may be used to correct the received data signals, improving decoding accuracy. In some examples, the receiver may perform interpolation and/or extrapolation to refine the channel estimates and handle variations in the channel conditions over time and frequency.

As shown in FIG. 5, the transmitter and receiver may communicate during multiple slots, shown as a slot 505 and a slot 510. In some examples, the receiver may perform DMRS-based channel estimation over a channel estimation window, shown in FIG. 5 as a channel estimation window 515, a channel estimation window 520, and a channel estimation window 525. As shown in FIG. 5, a slot may include one or more DMRS instances. In some examples, a DMRS instance may include a single symbol (e.g., a single OFDM symbol). In other examples, a DMRS instance may include multiple symbols (e.g., multiple OFDM symbols), such as two symbols. The receiver may perform a channel estimation using DMRSs received during a given channel estimation window. This enables a time domain density of DMRSs to be reduced. The receiver may receive and store information associated with the DMRSs in a channel estimation window and may interpolate the channel estimate using the information associated with the DMRSs received during the channel estimation window. In some examples, this approach may be referred to as DMRS bundling.

DMRS bundling may involve a receiver (e.g., a UE) performing joint channel estimation using information obtained from DMRSs received in multiple DMRS instances. For example, the joint channel estimation may be performed using information obtained from DMRSs received in a given channel estimation window (e.g., the channel estimation window 515, the channel estimation window 520, or the channel estimation window 525). FIG. 5 shows two DMRS instances in each channel estimation window as an example. In other examples, there may be any quantity of DMRS instances included in each channel estimation window. In some examples, a channel estimation window may span across multiple slots, such as shown by the channel estimation window 520.

A pattern of the DMRSs (or DMRS instances) may be indicated via one or more configuration parameters (e.g., RRC parameters or other parameters). For example, a DMRS configuration (e.g., DMRS-downlinkConfig for downlink DMRS configuration or DMRS-uplinkConfig for uplink DMRS configuration) may indicate DMRS position(s) within a slot. As an example, the DMRS configuration may indicate a DMRS mapping type, such as a DMRS Type A and a DMRS Type B. The DMRS mapping type may be indicative of a first OFDM symbol within a slot that includes a DMRS (e.g., for DMRS mapping Type A, a first DMRS within a slot may be included in symbol 2 or symbol 3 within the slot, and for DMRS mapping Type B, the DMRS starts at the first symbol of a TDRA for a physical channel (e.g., indicated by an SLIV as described elsewhere herein)). The DMRS configuration may indicate a DMRS configuration type (e.g., configuration type 1 or configuration type 2) which is indicative of a minimum resource element group in the frequency domain for the DMRS. The DMRS configuration may indicate additional DMRS positions within a slot using an additional position parameter (e.g., a dmrs-AdditionalPosition parameter). The additional position parameter may indicate one or more additional DMRS positions within a slot (e.g., where the positions are indicated relative to a start of the slot).

To ensure that a DMRS is transmitted for a physical channel, the DMRS may be configured within the TDRA for the physical channel. As an example, because the DMRS mapping Type A can only start at symbol 2 or symbol 3 within a slot, a TDRA that starts at symbol 4 or later within the slot cannot use DMRSs configured with the DMRS mapping Type A. Therefore, synchronization between the DMRS configuration or pattern and the TDRA for a physical channel ensures that the DMRS(s) are transmitted in connection with the physical channel, thereby enabling a receiver to perform channel estimation for the physical channel using the DMRS(s). As described above, DMRS configurations and/or patterns may be indicated relative to a slot structure or frame structure for a cell (e.g., the additional position parameter may indicate one or more additional DMRS positions and/or some DMRS mapping types may indicate DMRS positions relative to the slot structure). However, as described above, some TDRAs may be indicated by an SLIV that can span multiple slots. In such examples, the SLIV may be indicated independent of a slot structure configured for the cell (e.g., the SLIV may start or end at any point in time, rather than being confined to a single slot). Therefore, the DMRS configurations and/or patterns that rely on the fixed slot structure may not be suitable for TDRAs and/or SLIVs that can span multiple slots. For example, such DMRS configurations and/or patterns may result in a DMRS not being configured within a TDRA for the physical channel, or too few DMRSs being configured within the TDRA, thereby degrading channel estimation performance performed by a receiver using the DMRS(s). As another example, such DMRS configurations and/or patterns may result in more DMRSs than are needed for channel estimation being configured within a TDRA for the physical channel, thereby consuming network resources associated with communicating the DMRSs.

As indicated above, FIG. 5 is provided as an example. Other examples may differ from what is described with respect to FIG. 5.

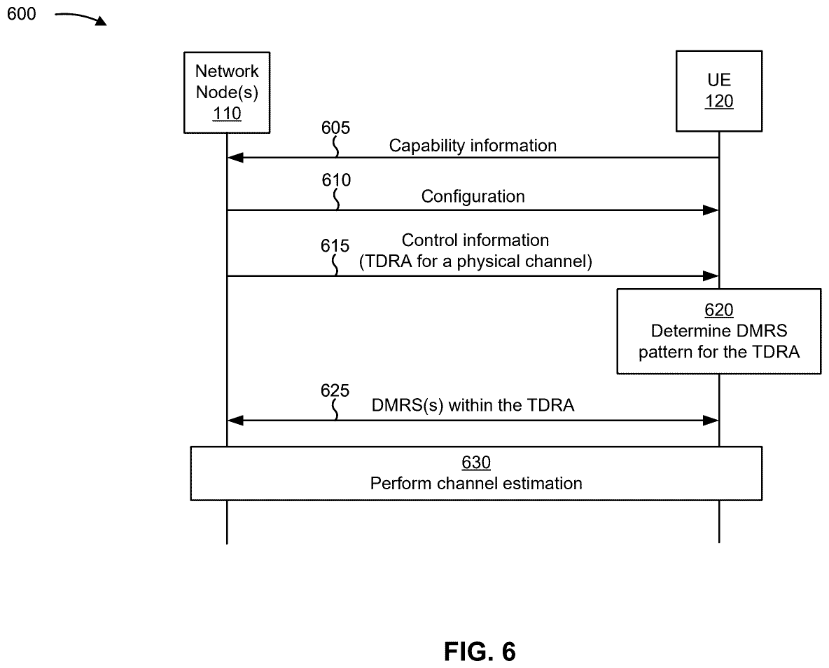

FIG. 6 is a diagram of an example 600 associated with signaling for a DMRS pattern, in accordance with the present disclosure. As shown in FIG. 6, one or more network nodes 110 (e.g., a base station, a CU, a DU, and/or an RU) may communicate with a UE 120. In some aspects, the network node(s) 110 and the UE 120 may be part of a wireless network (e.g., the wireless communication network 100). The UE 120 and the network node 110 may have established a wireless connection prior to operations shown in FIG. 6.

Some examples are described herein using DMRS as an example pilot symbol or pilot signal that is configured for channel estimation. However, the techniques and aspects described herein may be similarly applicable to other types of pilot signals, such as a phase tracking reference signal, a CRS, a CSI-RS, a beamforming reference signal, and/or one or more synchronization signals (for example, a PSS or SSS). Additionally, the techniques and aspects described herein may be applicable to downlink pilot signals, uplink pilot signals, and/or sidelink pilot signals.

Although some aspects are described herein using a symbol (e.g., an OFDM symbol) or a slot as an example time interval, the aspects and techniques described herein may be similarly applied to any time interval. The time interval may also be referred to as a time unit. For example, a time interval may include a frame, a subframe, a slot, a mini-slot (e.g., one or more symbols), a symbol (e.g., an OFDM symbol), a transmission time interval (TTI), a scheduling unit, and/or another time unit. For example, time domain spacings and/or time offsets for the DMRS pattern described herein may be indicated via a time interval other than a symbol, such as a mini-slot or a partial symbol.

In some aspects, as shown by reference number 605, the UE 120 may transmit capability information. The network node 110 may receive the capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a PUCCH, a PUSCH, a physical sidelink control channel (PSCCH), and/or a physical sidelink shared channel (PSSCH), among other examples. The capability information may indicate one or more parameters associated with respective capabilities of the UE 120. The one or more parameters may be indicated via respective IEs included in a capability report.

The capability information may indicate whether the UE 120 supports a feature and/or one or more parameters related to the feature. For example, the capability information may indicate a capability and/or parameter for the time domain spacing pattern information for DMRSs described herein. As another example, the capability information may indicate a capability and/or parameter for supporting receiving an SLIV that can indicate a TDRA that is not limited or confined to a single slot (e.g., a fluid SLIV). One or more operations described herein may be based on capability information. For example, the UE 120 may perform a communication in accordance with the capability information, or may receive configuration information that is in accordance with the capability information.

In some aspects, the capability information may indicate a DMRS processing window size supported by the UE 120. The DMRS processing window size may be a sliding window size or a DMRS processing window length indicating an amount of time during which the UE 120 is to store data samples and/or DMRS samples for channel estimation. The capability information may indicate a buffer capacity of the UE 120. The buffer capacity may indicate a size or memory capacity of a buffer of the UE 120 for storing data samples and/or DMRS samples for channel estimation. The buffer capacity may be indicative of the DMRS processing window size supported by the UE 120.

In some aspects, the capability information may indicate a quantity of DMRS symbols that can be processed by the UE 120 during a DMRS processing window. For example, the capability information may indicate one or more limitations (if any) on a maximum quantity of DMRS symbols that the UE 120 can process within each DMRS processing window (or each channel estimation window). For example, a higher degree of freedom for a physical channel in the time domain increases complexity of channel estimation by the UE 120, which may be associated with the UE 120 storing larger lookup tables for channel autocorrelation computation. In some aspects, the capability information may indicate a quantity of supported time domain bases for channel estimation supported by the UE 120 (e.g., a maximum quantity of time domain bases supported by the UE 120 for channel estimation). This may indicate a quantity of DMRS instances that can be configured within a given channel estimation window for the UE 120.

In some aspects, the capability information may indicate a time domain filtering capability for DMRS-based channel estimation. For example, the capability information may indicate whether the UE 120 supports (or is capable of) combining a channel estimate of a current channel estimation window with channel estimate(s) associated with one or more previous channel estimation windows (e.g., time domain filtering along the length of a TDRA). In some aspects, the capability information may indicate supported values or supported information for the time domain spacing pattern information described herein. For example, the capability information may indicate one or more supported values of the time domain spacing parameter described herein.

The network node 110 may determine time domain spacing pattern information for a DMRS configuration based on, or otherwise associated with, the capability information. For example, the network node 110 may determine one or more parameters in accordance with the capability information. As an example, the network node 110 may determine a time domain spacing parameter for the DMRS configuration to ensure that multiple DMRS instances are configured within a supported DMRS processing window (e.g., a channel estimation window) for the UE 120. As another example, the network node 110 may determine the time domain spacing pattern information to include values or information supported by the UE 120 as indicated by the capability information. In some other aspects, the network node 110 may determine at least a portion of the time domain spacing pattern information without (or independent of) the capability information. In such examples, the network node 110 may determine the time domain spacing pattern information using default or expected capabilities for the UE 120.

As shown by reference number 610, the network node 110 may transmit, and the UE 120 may receive, configuration information (e.g., a configuration). In some aspects, the UE 120 may receive the configuration information via one or more of system information (e.g., a master information block (MIB) and/or a system information block (SIB), among other examples), RRC signaling, MAC signaling (e.g., one or more medium access MAC-CEs), and/or physical layer signaling (e.g., DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may indicate that the UE 120 is to receive SLIVs that indicate TDRAs that are not confined or limited to a single slot (e.g., a fluid SLIV).

In some aspects, the configuration information may indicate time domain spacing pattern information (e.g., applicable for fluid SLIVs). The time domain spacing pattern information may indicate or include one or more parameters for defining a DMRS pattern within a given TDRA. The one or more parameters may enable the DMRS pattern to be defined relative to the TDRA (e.g., indicated by a fluid SLIV) without constraints to a fixed slot format (e.g., as the TDRA may cross a slot boundary and/or span multiple slots). For example, the one or more parameters may be indicative of a DMRS symbol bitmap (e.g., which may indicate DMRS symbol positions within a given TDRA).

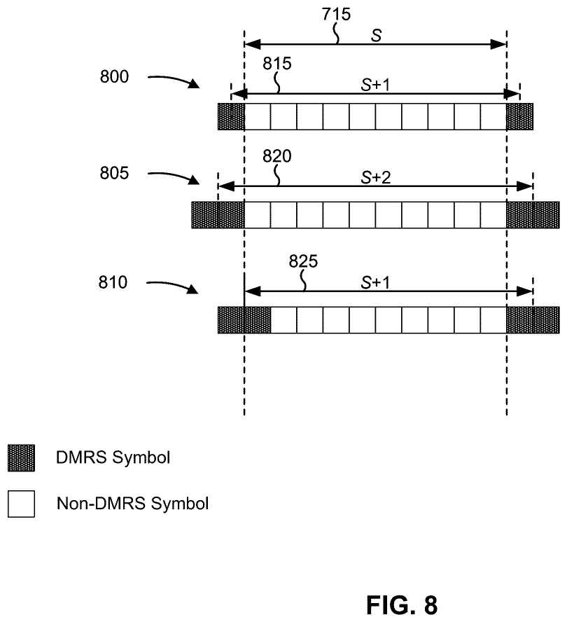

For example, the one or more parameters may include a time domain spacing parameter, a time domain offset parameter, and/or a window size parameter (e.g., a channel estimation window size or a DMRS processing window size for intra-SLIV or intra-TDRA DMRS combining for channel estimation), among other examples. The time domain spacing parameter may indicate an inter-DMRS spacing (e.g., in terms of a quantity of OFDM symbols) between DMRS instances in a given TDRA. The time domain spacing parameter may indicate one or more time gaps between DMRS instances included in a TDRA. For example, the time domain spacing parameter may indicate a uniform time gap that occurs between each DMRS instance included in the time domain resource allocation. In such examples, the time domain spacing parameter may indicate a single value which may indicate a time gap (e.g., a quantity of OFDM symbols) between each DMRS instance. The time gap(s) may be measured as depicted and described in more detail in connection with FIG. 8.

In other aspects, the time domain spacing parameter may indicate a non-uniform or unequal time domain spacing between DMRS instances included in a TDRA. For example, the inter-DMRS spacing may be constant or varying along the length of a TDRA. A largest or maximum time gap (e.g., indicated by the time domain spacing parameter for equal or unequal spacing) may be based on, or otherwise associated with, a buffer capacity or supported DMRS processing window for the UE 120 (e.g., as indicated via the capability information)

In some aspects, the time domain spacing parameter may be indicated from a set of available or possible values. In some aspects, the set of available or possible values may range from zero to W−1 (e.g., Q={0, 1, 2, 3, . . . , W−1}, where W is the length or size of the DMRS processing window (or channel estimation window) supported by the UE 120. In some aspects, the set of values for the time domain spacing parameter may be a subset (e.g., Q′) of all possible values (e.g., Q) for the time domain spacing parameter. For example, depending on the length or size of the DMRS processing window, a value of W may be large, resulting in many possible values of the time domain spacing parameter. The subset of values (e.g., Q′) may be selected or designed to address one or more Doppler scenarios or Doppler ranges (e.g., to ensure sufficient channel estimation parameters in various or common Doppler scenarios or Doppler ranges). This enables a signaling overhead associated with indicating the time domain spacing parameter to be reduced (e.g., because the subset of values Q′ may include fewer values than all possible values for the time domain spacing parameter, a smaller bit length may be used to indicate the time domain spacing parameter), while also providing sufficient flexibility for the network node 110 to configure a value of the time domain spacing parameter for various (e.g., common) Doppler scenarios. In some aspects, the network node 110 may select a value for the time domain spacing parameter from a subset of values that is defined, or otherwise fixed, by a wireless communication standard, such as the 3GPP. For example, the network node 110 may indicate the time domain spacing parameter using ┌log 2(W′)┐ bits, where W′ is the quantity of values included in the subset of values (e.g., Q′).

In some aspects, a given or defined value of the time domain spacing parameter may indicate that a single DMRS instance is configured or is to occur in each TDRA. For example, a value (e.g., zero) of the time domain spacing parameter may indicate that a TDRA includes a single DMRS instance.

In some aspects, the configuration information may indicate a nominal value for the time domain spacing parameter that can be later modified or updated via additional signaling (e.g., such as depicted and described in more detail in connection with reference number 615), such as physical layer signaling or DCI signaling. In some aspects, the configuration information may indicate multiple values of the time domain spacing parameter. In such examples, a single value from the multiple values may be indicated via additional signaling (e.g., such as depicted and described in more detail in connection with reference number 615), such as physical layer signaling or DCI signaling.

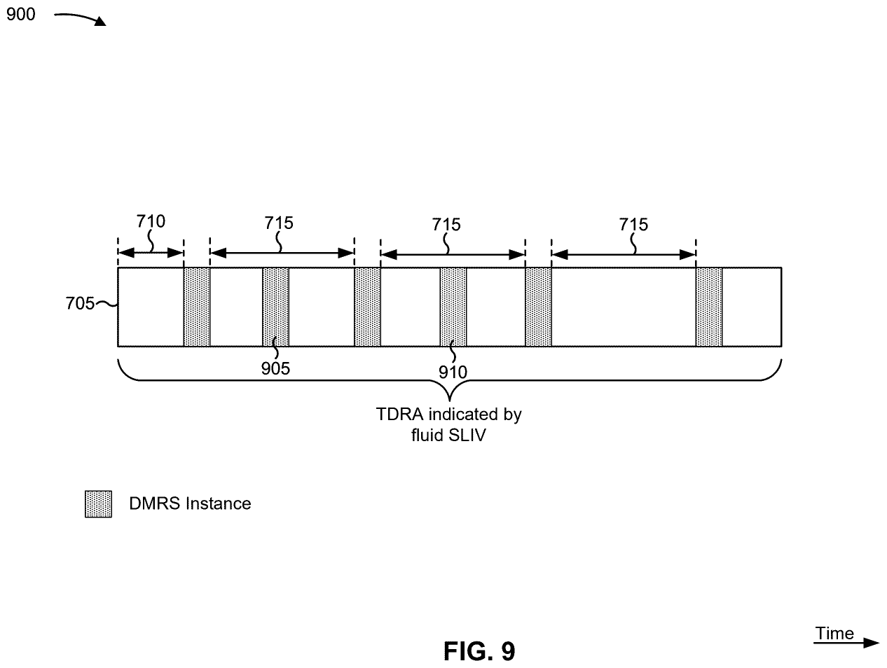

In some aspects, the time domain spacing parameter may indicate an uneven or unequal time domain spacing between DMRS instances. For example, the time domain spacing parameter may indicate unequal time gaps that occur between pairs of DMRS instances included in a TDRA. For example, the time domain spacing parameter may indicate that DMRS symbols are spaced at unequal time gaps along a TDRA. For example, the configuration information may indicate a time domain spacing parameter that indicates an equal time gap between DMRS instances. The equal time gap may define one or more DMRS intervals or time intervals within the TDRA (e.g., where a DMRS interval or time interval has a size based on, or equal to, the time gap indicated by the time domain spacing parameter). In such examples, the network node 110 may configure an uneven or unequal time domain spacing by indicating one or more other parameters via the configuration information. The one or more other parameters may indicate that one or more time DMRS intervals, from the set of DMRS intervals, are to include one or more DMRS instances during the one or more DMRS intervals. For example, the configuration information may indicate that a first (or last) n DMRS intervals are to include an additional x DMRS instances (e.g., where n and x are included in the one or more other parameters indicated by the configuration information). In such examples, the x DMRS instances may be equally spaced (e.g., in time) within each of the n DMRS intervals. This example is depicted and described in more detail in connection with FIG. 9.

As another example, the network node 110 may indicate uneven or unequal time domain spacing between DMRS instances by indicating a set of time gaps (e.g., a set of values for the time domain spacing parameter) having unequal durations or values. For example, the configuration information may indicate quantities of pairs of DMRS instances (or DMRS intervals) for which respective time gaps, from the set of time gaps, are applicable. As an example, the configuration information may indicate a set of values for the time domain spacing parameter (2, 4, 6, 8). The configuration information may indicate quantities of pairs of DMRS instances of (3, 2, 1, 1) (e.g., the configuration information may indicate a sequence of {(2, 4, 6, 8), (3, 2, 1, 1)}). This may indicate that the first three pairs of DMRS instances are to be separated by two OFDM symbols (e.g., the first three DMRS intervals are to have a length of two OFDM symbols), the next two pairs of DMRS instances are to be separated by four OFDM symbols (e.g., the next two DMRS intervals are to have a length of four OFDM symbols), the next pair of DMRS instances is to be separated by six OFDM symbols (e.g., the next DMRS interval is to have a length of six OFDM symbols), and a last pair of DMRS instances is to be separated by eight OFDM symbols (e.g., the last DMRS interval is to have a length of eight OFDM symbols). For example, the configuration information may indicate one or more (ascending) sequences of values of the time domain spacing parameter and corresponding quantities of inter-DMRS intervals for application of these values. The UE 120 may assume that DMRS instances have spacings according to the sequence(s).

Additionally, or alternatively, the configuration information may indicate the time domain offset parameter. The time domain offset parameter may indicate a starting time domain location of a first DMRS instance (e.g., first in the time domain) included in a TDRA. For example, the time domain offset parameter may indicate a time offset relative to a start of a TDRA. In some other examples, the time domain offset parameter may indicate a time offset relative to a start of a first slot included in the TDRA (e.g., a first full slot or a first slot in which the SLIV indicates the TDRA is to begin). The time offset may indicate a quantity of OFDM symbols (if any) between the first DMRS instance and the start of the TDRA (or the start of a slot). For example, the time offset may indicate a quantity of OFDM symbols to be extrapolated for channel estimation. In some aspects, the time domain offset parameter may indicate a value of zero (e.g., indicating that the first DMRS instance is to occur in a first symbol of the TDRA or a first symbol of the first slot). In some other aspects, the time domain offset parameter may indicate a value of greater than zero (e.g., indicating that the first DMRS instance is to occur a certain quantity of symbols after a first symbol of the TDRA or after a first symbol of the first slot).

In some aspects, the time domain offset parameter (or another parameter) may indicate whether a DMRS instance is to occur in a last symbol of the TDRA. For example, the configuration information may indicate how many symbols are included in the TDRA after the last DMRS symbol. In some examples, this information may be explicitly indicated via a parameter included in the configuration information. In other examples, this information may be implicitly indicated (e.g., the UE 120 may determine this information based on the time domain spacing parameter, the time domain offset parameter, and/or other DMRS configuration information).

In some aspects, the configuration information may indicate a window size (e.g., a DMRS processing window size or a channel estimation window size) for channel estimation. The window may be a sliding window. The UE 120 may combine DMRS information across windows for intra-TDRA DMRS combining when performing channel estimation. In some aspects, the network node 110 may configure at least two DMRS instances in each window. In some aspects, different windows may have different DMRS patterns (e.g., different time domain spacing pattern information, different time domain spacing parameters, and/or different time domain offset parameters) within a given TDRA.

The UE 120 may configure itself based at least in part on the configuration information. In some aspects, the UE 120 may be configured to perform one or more operations described herein based at least in part on the configuration information.

As shown by reference number 615, the network node 110 may transmit, and the UE 120 may receive, control information. The network node 110 may transmit, and the UE 120 may receive, the control information via physical layer signaling, such as via a control communication. For example, the control information may be DCI. In other examples, the control information may be another type of control information, such as UCI (e.g., if indicated by the UE 120), sidelink control information (e.g., for communication between two UEs), or other control information.

In some aspects, the control information may indicate an SLIV. The SLIV may be a fluid SLIV (e.g., that is configured or that can indicate a TDRA that is not constrained to being placed within a single slot). For example, the SLIV may indicate a TDRA (e.g., that is not constrained to being placed within a single slot). The TDRA may be for a physical channel, such as the PUSCH, the PDSCH, the PSSCH, a physical broadcast channel (PBCH), or another physical channel. The SLIV may indicate the TDRA in a similar manner as described in connection with FIG. 4.

In some aspects, at least a portion of the time domain spacing pattern information described herein may be indicated via the control information. In some aspects, some of the time domain spacing pattern information may be indicated in the control information that indicates the SLIV (e.g., that schedules or allocates the TDRA). In other examples, the time domain spacing pattern information may be indicated in separate control information (e.g., a separate DCI than DCI that indicates the SLIV). In such examples, the time domain spacing pattern information may be indicated using a DCI format that is defined or associated with indicating DMRS pattern information.

As an example, the control information may indicate or modify the time domain spacing parameter described herein. For example, the configuration information may indicate a first value of the time domain spacing parameter that indicates a first time gap. The control information (e.g., a control communication) may indicate information that updates, modifies, or otherwise changes the first time gap. For example, the control information may indicate a spacing offset parameter indicative of a second time gap that is associated with the first time gap. The second time gap may be associated with the first time gap in that the UE 120 may determine or derive the second time gap using the first time gap and the spacing offset parameter. The spacing offset parameter may indicate a value (e.g., an absolute value) to be used to modify the first time gap to obtain the second time gap. For example, the spacing offset parameter may indicate a value by which the value of the time domain spacing parameter (e.g., indicated via the configuration information) is to be modified. For example, the UE 120 may add or subtract the value of the spacing offset parameter from the value of the time domain spacing parameter (e.g., indicated via the configuration information) to obtain the second time gap. The UE 120 may use the second time gap to determine the DMRS pattern for the TDRA, as described in more detail elsewhere herein.

As another example, the control information (e.g., a control communication) may indicate a scaling factor to be applied to the first time gap to obtain the second time gap. For example, DCI may indicate a scaling factor to be applied to the time gap indicated by the configuration information. In other examples, the network node 110 may be configured to indicate an offset to the time domain spacing parameter up to a maximum offset value. The scaling factor may be applied to the maximum offset value for slot-by-slot DMRS spacing calculations (e.g., where a spacing between DMRS instances is a maximum of (1, S−αΔSₘₐₓ), where S is the time domain offset parameter indicated by the configuration information, a is the scaling factor, and ΔSₘₐₓ is the maximum offset value).

As another example, the configuration information may indicate a set of values for the time domain spacing parameter (e.g., as described elsewhere herein). In such examples, the control information may indicate a single value (e.g., by indicating an index of a given value from the set of values for the time domain spacing parameter) for the time domain spacing parameter. This enables the time domain spacing parameter to be indicated or selected for each TDRA (e.g., on a per-SLIV basis). In some aspects, the set of values may be additionally modified (e.g., by the spacing offset parameter) in a similar manner as described above.

As shown by reference number 620, the UE 120 may determine the DMRS pattern for the TDRA. For example, the UE 120 may determine one or more DMRS instance locations at respective time domain locations that are based at least in part on the SLIV and the time domain spacing pattern information. For example, the UE 120 may determine a starting location of a first DMRS instance based on the time domain offset parameter described herein. Additionally, the UE 120 may determine a time domain spacing between DMRS instances based on the time domain spacing parameter (and/or the control information). A size of the TDRA (e.g., indicated by the SLIV) may indicate a quantity of DMRS instances that are to be included in the TDRA. For example, if the size of the TDRA is 20 symbols, the starting location of a first DMRS instance is 4 symbols from the start of the TDRA, and the time domain spacing parameter indicates a spacing of 5 symbols, then there may be 4 DMRS instances included in the TDRA (e.g., starting at the symbol 4, the symbol 9, the symbol 14, and the symbol 19).

As shown by reference number 625, the UE 120 and the network node 110 may communicate one or more DMRSs at the respective time domain locations indicated by the DMRS pattern (e.g., as determined by the UE 120 as described in connection with reference number 620). For example, if the TDRA is a PUSCH TDRA, then the UE 120 may transmit, and the network node 110 may receive, the one or more DMRSs. As another example, if the TDRA is a PDSCH TDRA, then the network node 110 may transmit, and the UE 120 may receive, the one or more DMRSs.

As shown by reference number 630, the UE 120 or the network node 110 may perform channel estimation using the one or more DMRSs. For example, the channel estimation may be performed in a similar manner as described in more detail elsewhere herein, such as in connection with FIG. 5.

As indicated above, FIG. 6 is provided as an example. Other examples may differ from what is described with respect to FIG. 6.

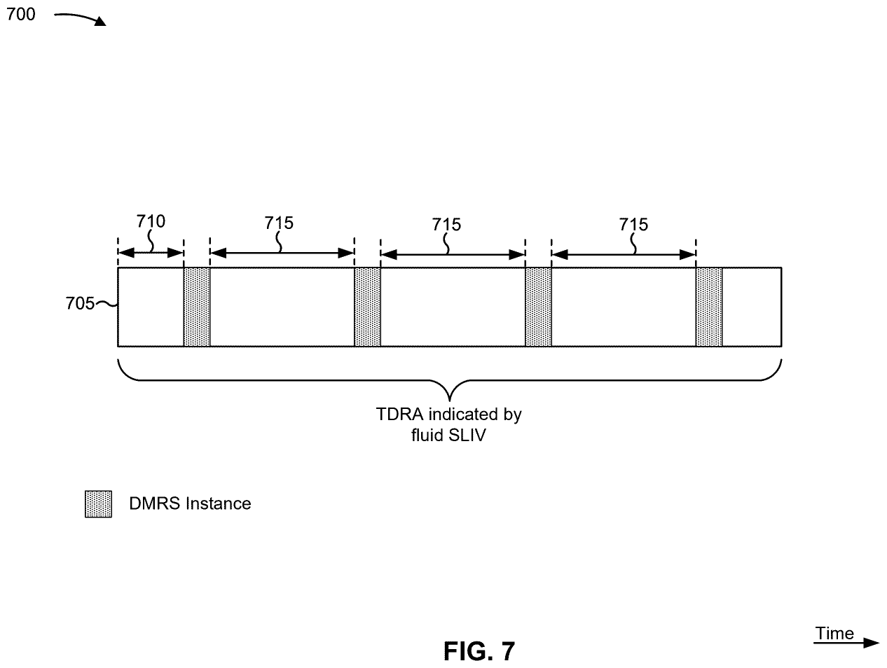

FIG. 7 is a diagram of an example 700 associated with a DMRS pattern, in accordance with the present disclosure. FIG. 7 shows an example of equal spacing between DMRS instances within a TDRA 705. The TDRA 705 may be indicated by a fluid SLIV, as described in more detail elsewhere herein.

The time domain locations of the DMRS instances may be indicated via one or more configuration parameters and/or control information, as described in more detail elsewhere herein. For example, the time domain offset parameter may indicate a time offset 710 that indicates a location of a first DMRS instance within the TDRA 705. Example 700 shows the time offset 710 being relative to the start of the TDRA 705.

As shown in FIG. 7, there may be equal or uniform time gaps 715 between DMRS instances within the TDRA 705. A size or length of the time gap(s) 715 may be indicated by the time domain spacing parameter. For example, the time domain spacing parameter may indicate a value that is indicative of the time gaps 715. As described elsewhere herein, the quantity of DMRS instances (e.g., four as shown in FIG. 7) included in the TDRA 705 may be based on the size of the TDRA 705, the time offset 710, and the time gaps 715. A quantity of symbols included in each DMRS instance and frequency domain patterns or locations of the DMRSs may be indicated via other configuration parameters, such as a DMRS configuration type, a DMRS mapping type, and/or other parameters.

As indicated above, FIG. 7 is provided as an example. Other examples may differ from what is described with respect to FIG. 7.

FIG. 8 is a diagram of an example associated with DMRS instance spacing in a DMRS pattern, in accordance with the present disclosure. As shown in FIG. 8, and as described in more detail elsewhere herein, the network node 110 may indicate that a pair of DMRS instances (shown in FIG. 8 as DMRS symbols) are to be separated in the time domain by a time gap 715 (e.g., indicated by a time domain spacing parameter, shown as S in FIG. 8).

In some aspects, as shown by reference number 800, in examples where the DMRS instances each include a single symbol (e.g., for examples that do not use a time domain orthogonal cover code (TDOCC)), the time gap 715 may be measured from an end of the DMRS for a first DMRS instance to a start of a DMRS symbol for a next DMRS instance. As shown in FIG. 8, this results in a time gap 815 (e.g., a time gap between average time domain locations for the two DMRS instances) of S+1 (e.g., where one is a single OFDM symbol in addition to a quantity of OFDM symbols indicated by the time domain spacing parameter).

In some other examples, each DMRS instances may include two (or more) DMRS symbols. For example, the UE 120 and/or the network node 110 may apply a TDOCC applied to DMRSs (e.g., for supporting single user MIMO with a rank that satisfies a threshold (such as a rank larger than four) or for some multi-user MIMO configurations), the network node 110 and the UE 120 may use the same type of time domain spacing parameter to indicate the time gap 715.

In some examples, as shown by reference number 805, the time domain spacing parameter may indicate the time gap 715 relative to a last DMRS symbol of a first DMRS instance and a first DMRS symbol of a second DMRS instance (e.g., where the first DMRS instance occurs earlier in time than the second DMRS instance). This results in a time gap 820 (e.g., a time gap between average time domain locations for the two DMRS instances) of S+2 (e.g., where two is two OFDM symbols in addition to a quantity of OFDM symbols indicated by the time domain spacing parameter).

As another example, as shown by reference number 810, the time domain spacing parameter may indicate the time gap 715 relative to first DMRS symbols of respective DMRS instances of a first DMRS instance and a second DMRS instance (e.g., where the first DMRS instance occurs earlier in time than the second DMRS instance). For example, the time gap 715 may be measured from the end of the first DMRS symbol in each DMRS instance. As shown in FIG. 8, this results in a time gap 825 (e.g., a time gap between average time domain locations for the two DMRS instances) of S+1 (e.g., where one is a single OFDM symbol in addition to a quantity of OFDM symbols indicated by the time domain spacing parameter).

As indicated above, FIG. 8 is provided as an example. Other examples may differ from what is described with respect to FIG. 8.

FIG. 9 is a diagram of an example 900 associated with a DMRS pattern, in accordance with the present disclosure. FIG. 9 shows an example of unequal spacing between DMRS instances within the TDRA 705. The TDRA 705 may be indicated by a fluid SLIV, as described in more detail elsewhere herein, such as in connection with FIG. 7.

The time domain locations of the DMRS instances may be indicated via one or more configuration parameters and/or control information, as described in more detail elsewhere herein. For example, the time domain offset parameter may indicate a time offset 710 that indicates a location of a first DMRS instance within the TDRA 705. Example 700 shows the time offset 710 being relative to the start of the TDRA 705.

As shown in FIG. 9, there may be equal or uniform time gaps 715 between some DMRS instances within the TDRA 705. A size or length of the time gap(s) 715 may be indicated by the time domain spacing parameter. The time gap(s) 715 may define or indicate DMRS intervals. The network node 110 may indicate or configure the unequal time domain spacing by indicating that there are one or more DMRS instances included within some DMRS intervals. For example, as shown in FIG. 9, the network node 110 may indicate that a DMRS instance 905 is included in a first DMRS interval and a DMRS instance 910 is included in a second DMRS instance. For example, the configuration information described herein may indicate that the first two DMRS intervals within the TDRA 705 are to include an additional DMRS instance (e.g., a single additional DMRS instance as shown in FIG. 9). In other examples, one or more DMRS intervals may include more than one additional DMRS instance. The additional DMRS instance(s) may be spaced with equal time gaps (e.g., in the time domain) within a DMRS interval, as explained in more detail elsewhere herein, such as in connection with FIG. 8.

As indicated above, FIG. 9 is provided as an example. Other examples may differ from what is described with respect to FIG. 9.

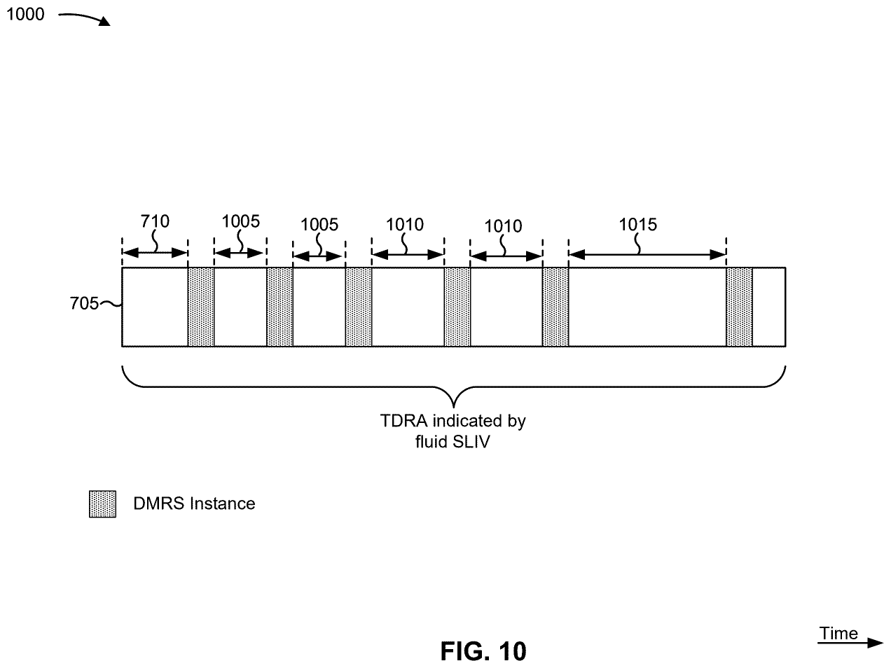

FIG. 10 is a diagram of an example 1000 associated with a DMRS pattern, in accordance with the present disclosure. FIG. 10 shows an example of unequal spacing between DMRS instances within the TDRA 705. The TDRA 705 may be indicated by a fluid SLIV, as described in more detail elsewhere herein, such as in connection with FIG. 7.

The time domain locations of the DMRS instances may be indicated via one or more configuration parameters and/or control information, as described in more detail elsewhere herein. For example, the time domain offset parameter may indicate a time offset 710 that indicates a location of a first DMRS instance within the TDRA 705. Example 700 shows the time offset 710 being relative to the start of the TDRA 705.

As shown in FIG. 10, there may be different time gaps between different DMRS instances. For example, the configuration information may indicate multiple values for the time domain spacing parameter that are applicable to respective DMRS intervals. For example, as shown in FIG. 10, a first two DMRS intervals within the TDRA 705 may have a time gap 1005, a next two DMRS intervals within the TDRA 705 may have a time gap 1010, and a last DMRS interval within the TDRA 705 may have a time gap 1015. As an example, the configuration information may include a sequence of values (e.g., indicating values for the time gap 1005, the time gap 1010, and the time gap 1015) and respective quantities of DMRS intervals to which the values are applicable (e.g., two, two, and one in the example shown in FIG. 10).

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with a DMRS pattern.

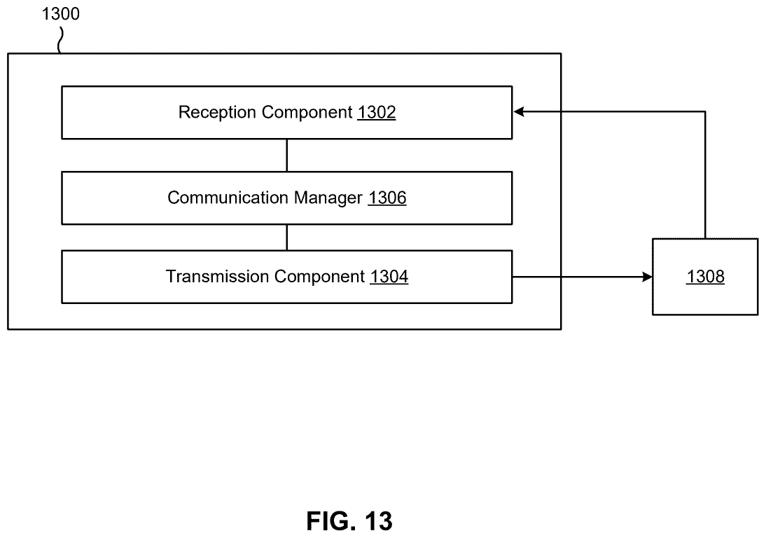

As shown in FIG. 11, in some aspects, process 1100 may include receiving a configuration indicating a time domain spacing pattern information for a DMRS, the time domain spacing pattern information indicating a time domain spacing parameter and a time domain offset parameter (block 1110). For example, the UE (e.g., using reception component 1302 and/or communication manager 1306, depicted in FIG. 13) may receive a configuration indicating a time domain spacing pattern information for a DMRS, the time domain spacing pattern information indicating a time domain spacing parameter and a time domain offset parameter, as described above.

As further shown in FIG. 11, in some aspects, process 1100 may include receiving an SLIV indicating a time domain resource allocation associated with a channel (block 1120). For example, the UE (e.g., using reception component 1302 and/or communication manager 1306, depicted in FIG. 13) may receive an SLIV indicating a time domain resource allocation associated with a channel, as described above. The channel may be a shared channel or a data channel, such as the PUSCH, the PDSCH, or the PSSCH, among other examples.

As further shown in FIG. 11, in some aspects, process 1100 may include communicating, during the time domain resource allocation, one or more DMRSs associated with the channel at respective time domain locations that are based at least in part on the SLIV and the time domain spacing pattern information (block 1130). For example, the UE (e.g., using reception component 1302, transmission component 1304, and/or communication manager 1306, depicted in FIG. 13) may communicate, during the time domain resource allocation, one or more DMRSs associated with the channel at respective time domain locations that are based at least in part on the SLIV and the time domain spacing pattern information, as described above.

Process 1100 may include additional aspects, such as any single aspect or any combination of aspects described below and/or in connection with one or more other processes described elsewhere herein.

In a first aspect, the time domain spacing parameter indicates one or more time gaps between DMRS instances included in the time domain resource allocation.

In a second aspect, alone or in combination with the first aspect, the time domain spacing parameter indicates a uniform time gap that occurs between each DMRS instance included in the time domain resource allocation.

In a third aspect, alone or in combination with one or more of the first and second aspects, a value of the time domain spacing parameter indicates that the time domain resource allocation includes a single DMRS instance.

In a fourth aspect, alone or in combination with one or more of the first through third aspects, the time domain offset parameter indicates a starting time domain location of a first DMRS instance included in the time domain resource allocation.

In a fifth aspect, alone or in combination with one or more of the first through fourth aspects, the time domain offset parameter indicates a time offset relative to a start of the time domain resource allocation.

In a sixth aspect, alone or in combination with one or more of the first through fifth aspects, the time domain offset parameter indicates a time offset relative to a start of a first slot included in the time domain resource allocation.

In a seventh aspect, alone or in combination with one or more of the first through sixth aspects, the time domain spacing parameter indicates a time gap relative to a last DMRS symbol of a first DMRS instance and a first DMRS symbol of a second DMRS instance, wherein the first DMRS instance occurs earlier in time than the second DMRS instance.

In an eighth aspect, alone or in combination with one or more of the first through seventh aspects, the time domain spacing parameter indicates a time gap relative to first DMRS symbols of respective DMRS instances of a first DMRS instance and a second DMRS instance, wherein the first DMRS instance occurs earlier in time than the second DMRS instance.

In a ninth aspect, alone or in combination with one or more of the first through eighth aspects, wherein the time domain spacing parameter indicates a first time gap, and process 1100 includes receiving a control communication that indicates a spacing offset parameter indicative of a second time gap that is associated with the first time gap, and wherein the respective time domain locations are based on the second time gap.

In a tenth aspect, alone or in combination with one or more of the first through ninth aspects, the spacing offset parameter indicates a value to be used to modify the first time gap to obtain the second time gap.

In an eleventh aspect, alone or in combination with one or more of the first through tenth aspects, the time domain spacing parameter indicates a scaling factor to be applied to the first time gap to obtain the second time gap.

In a twelfth aspect, alone or in combination with one or more of the first through eleventh aspects, wherein the time domain spacing parameter indicates multiple time gaps, and process 1100 includes receiving a control communication that indicates a time gap from the multiple time gaps, and wherein the respective time domain locations are based on the time gap.

In a thirteenth aspect, alone or in combination with one or more of the first through twelfth aspects, the time domain spacing parameter indicates unequal time gaps that occur between pairs of DMRS instances included in the time domain resource allocation.

In a fourteenth aspect, alone or in combination with one or more of the first through thirteenth aspects, the time domain spacing parameter indicates a set of time intervals between first DMRS instances, and the configuration indicates that one or more time intervals, from the set of time intervals, are to include one or more DMRS instances during the one or more time intervals.

In a fifteenth aspect, alone or in combination with one or more of the first through fourteenth aspects, the configuration indicates a quantity of DMRS instances to occur during respective time intervals of the one or more time intervals.

In a sixteenth aspect, alone or in combination with one or more of the first through fifteenth aspects, the time domain spacing parameter indicates a set of time gaps having unequal durations.

In a seventeenth aspect, alone or in combination with one or more of the first through sixteenth aspects, the configuration indicates quantities of pairs of DMRS instances for which respective time gaps, from the set of time gaps, are applicable.

In an eighteenth aspect, alone or in combination with one or more of the first through seventeenth aspects, process 1100 includes transmitting capability information associated with the time domain spacing pattern information.

In a nineteenth aspect, alone or in combination with one or more of the first through eighteenth aspects, the capability information indicates at least one of a DMRS processing window size, a buffer capacity, a quantity of DMRS symbols that can be processed during a DMRS processing window, a quantity of supported time domain bases for channel estimation, or a time domain filtering capability for DMRS-based channel estimation.

In a twentieth aspect, alone or in combination with one or more of the first through nineteenth aspects, the time domain resource allocation spans multiple slots.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with demodulation reference signal pattern.

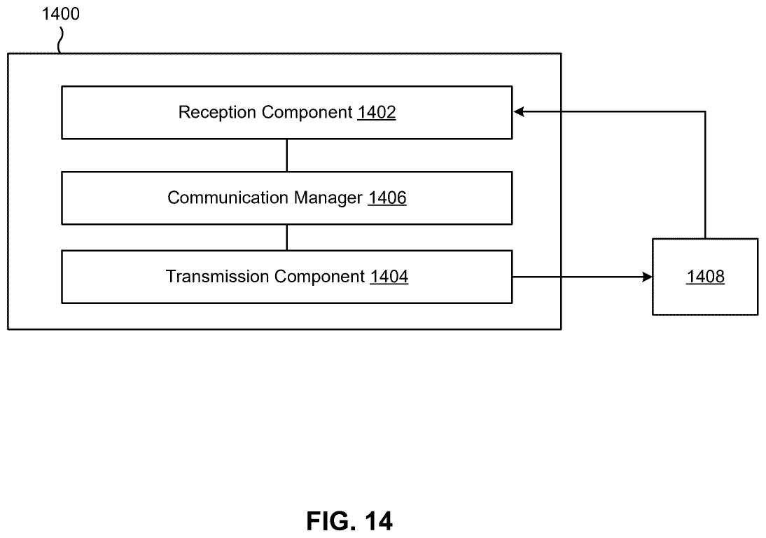

As shown in FIG. 12, in some aspects, process 1200 may include transmitting, for a UE, a configuration indicating a time domain spacing pattern information for a DMRS, the time domain spacing pattern information indicating a time domain spacing parameter and a time domain offset parameter (block 1210). For example, the network node (e.g., using transmission component 1404 and/or communication manager 1406, depicted in FIG. 14) may transmit, for a UE, a configuration indicating a time domain spacing pattern information for a DMRS, the time domain spacing pattern information indicating a time domain spacing parameter and a time domain offset parameter, as described above.

As further shown in FIG. 12, in some aspects, process 1200 may include transmitting, for the UE, an SLIV indicating a time domain resource allocation associated with a channel (block 1220). For example, the network node (e.g., using transmission component 1404 and/or communication manager 1406, depicted in FIG. 14) may transmit, for the UE, an SLIV indicating a time domain resource allocation associated with a channel, as described above. The channel may be a shared channel or a data channel, such as the PUSCH, the PDSCH, or the PSSCH, among other examples.

As further shown in FIG. 12, in some aspects, process 1200 may include communicating, for the UE and during the time domain resource allocation, one or more DMRSs associated with the channel at respective time domain locations that are based at least in part on the SLIV and the time domain spacing pattern information (block 1230). For example, the network node (e.g., using reception component 1402, transmission component 1404, and/or communication manager 1406, depicted in FIG. 14) may communicate, for the UE and during the time domain resource allocation, one or more DMRSs associated with the channel at respective time domain locations that are based at least in part on the SLIV and the time domain spacing pattern information, as described above.

Process 1200 may include additional aspects, such as any single aspect or any combination of aspects described below and/or in connection with one or more other processes described elsewhere herein.

In a first aspect, the time domain spacing parameter indicates one or more time gaps between DMRS instances included in the time domain resource allocation.

In a second aspect, alone or in combination with the first aspect, the time domain spacing parameter indicates a uniform time gap that occurs between each DMRS instance included in the time domain resource allocation.

In a third aspect, alone or in combination with one or more of the first and second aspects, a value of the time domain spacing parameter indicates that the time domain resource allocation includes a single DMRS instance.

In a fourth aspect, alone or in combination with one or more of the first through third aspects, the time domain offset parameter indicates a starting time domain location of a first DMRS instance included in the time domain resource allocation.

In a fifth aspect, alone or in combination with one or more of the first through fourth aspects, the time domain offset parameter indicates a time offset relative to a start of the time domain resource allocation.

In a sixth aspect, alone or in combination with one or more of the first through fifth aspects, the time domain offset parameter indicates a time offset relative to a start of a first slot included in the time domain resource allocation.

In a seventh aspect, alone or in combination with one or more of the first through sixth aspects, the time domain spacing parameter indicates a time gap relative to a last DMRS symbol of a first DMRS instance and a first DMRS symbol of a second DMRS instance, wherein the first DMRS instance occurs earlier in time than the second DMRS instance.

In an eighth aspect, alone or in combination with one or more of the first through seventh aspects, the time domain spacing parameter indicates a time gap relative to first DMRS symbols of respective DMRS instances of a first DMRS instance and a second DMRS instance, wherein the first DMRS instance occurs earlier in time than the second DMRS instance.

In a ninth aspect, alone or in combination with one or more of the first through eighth aspects, wherein the time domain spacing parameter indicates a first time gap, and process 1200 includes transmitting a control communication that indicates a spacing offset parameter indicative of a second time gap that is associated with the first time gap, and wherein the respective time domain locations are based on the second time gap.

In a tenth aspect, alone or in combination with one or more of the first through ninth aspects, the spacing offset parameter indicates a value to be used to modify the first time gap to obtain the second time gap.

In an eleventh aspect, alone or in combination with one or more of the first through tenth aspects, the time domain spacing parameter indicates a scaling factor to be applied to the first time gap to obtain the second time gap.

In a twelfth aspect, alone or in combination with one or more of the first through eleventh aspects, wherein the time domain spacing parameter indicates multiple time gaps, and process 1200 includes transmitting a control communication that indicates a time gap from the multiple time gaps, and wherein the respective time domain locations are based on the time gap.

In a thirteenth aspect, alone or in combination with one or more of the first through twelfth aspects, the time domain spacing parameter indicates unequal time gaps that occur between pairs of DMRS instances included in the time domain resource allocation.

In a fourteenth aspect, alone or in combination with one or more of the first through thirteenth aspects, the time domain spacing parameter indicates a set of time intervals between first DMRS instances, and the configuration indicates that one or more time intervals, from the set of time intervals, are to include one or more DMRS instances during the one or more time intervals.

In a fifteenth aspect, alone or in combination with one or more of the first through fourteenth aspects, the configuration indicates a quantity of DMRS instances to occur during respective time intervals of the one or more time intervals.

In a sixteenth aspect, alone or in combination with one or more of the first through fifteenth aspects, the time domain spacing parameter indicates a set of time gaps having unequal durations.

In a seventeenth aspect, alone or in combination with one or more of the first through sixteenth aspects, the configuration indicates quantities of DMRS instances for which respective time gaps, from the set of time gaps, are applicable.

In an eighteenth aspect, alone or in combination with one or more of the first through seventeenth aspects, process 1200 includes receiving capability information associated with the time domain spacing pattern information.

In a nineteenth aspect, alone or in combination with one or more of the first through eighteenth aspects, the capability information indicates at least one of a DMRS processing window size, a buffer capacity, a quantity of DMRS symbols that can be processed during a DMRS processing window, a quantity of supported time domain basis for channel estimation, or a time domain filtering capability for DMRS-based channel estimation.

In a twentieth aspect, alone or in combination with one or more of the first through nineteenth aspects, the time domain resource allocation spans multiple slots.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a configuration indicating a time domain spacing pattern information for a DMRS, the time domain spacing pattern information indicating a time domain spacing parameter and a time domain offset parameter. The reception component 1302 may receive an SLIV indicating a time domain resource allocation associated with a channel. The reception component 1302 and/or the transmission component 1304 may communicate, during the time domain resource allocation, one or more DMRSs associated with the channel at respective time domain locations that are based at least in part on the SLIV and the time domain spacing pattern information.

The transmission component 1304 may transmit capability information associated with the time domain spacing pattern information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit, for a UE, a configuration indicating a time domain spacing pattern information for a DMRS, the time domain spacing pattern information indicating a time domain spacing parameter and a time domain offset parameter. The transmission component 1404 may transmit, for the UE, an SLIV indicating a time domain resource allocation associated with a channel. The reception component 1402 and/or the transmission component 1404 may communicate, for the UE and during the time domain resource allocation, one or more DMRSs associated with the channel at respective time domain locations that are based at least in part on the SLIV and the time domain spacing pattern information.

The reception component 1402 may receive capability information associated with the time domain spacing pattern information.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a configuration indicating a time domain spacing pattern information for a demodulation reference signal (DMRS), the time domain spacing pattern information indicating a time domain spacing parameter and a time domain offset parameter; receiving a start and length indicator value (SLIV) indicating a time domain resource allocation associated with a channel; and communicating, during the time domain resource allocation, one or more DMRSs associated with the channel at respective time domain locations that are based at least in part on the SLIV and the time domain spacing pattern information.

Aspect 2: The method of Aspect 1, wherein the time domain spacing parameter indicates one or more time gaps between DMRS instances included in the time domain resource allocation.

Aspect 3: The method of any of Aspects 1-2, wherein the time domain spacing parameter indicates a uniform time gap that occurs between each DMRS instance included in the time domain resource allocation.

Aspect 4: The method of any of Aspects 1-3, wherein a value of the time domain spacing parameter indicates that the time domain resource allocation includes a single DMRS instance.

Aspect 5: The method of any of Aspects 1-4, wherein the time domain offset parameter indicates a starting time domain location of a first DMRS instance included in the time domain resource allocation.

Aspect 6: The method of Aspect 5, wherein the time domain offset parameter indicates a time offset relative to a start of the time domain resource allocation.

Aspect 7: The method of Aspect 5, wherein the time domain offset parameter indicates a time offset relative to a start of a first slot included in the time domain resource allocation.

Aspect 8: The method of any of Aspects 1-7, wherein the time domain spacing parameter indicates a time gap relative to a last DMRS symbol of a first DMRS instance and a first DMRS symbol of a second DMRS instance, wherein the first DMRS instance occurs earlier in time than the second DMRS instance.

Aspect 9: The method of any of Aspects 1-8, wherein the time domain spacing parameter indicates a time gap relative to first DMRS symbols of respective DMRS instances of a first DMRS instance and a second DMRS instance, wherein the first DMRS instance occurs earlier in time than the second DMRS instance.

Aspect 10: The method of any of Aspects 1-9, wherein the time domain spacing parameter indicates a first time gap, the method further comprising: receiving a control communication that indicates a spacing offset parameter indicative of a second time gap that is associated with the first time gap, and wherein the respective time domain locations are based on the second time gap.

Aspect 11: The method of Aspect 10, wherein the spacing offset parameter indicates a value to be used to modify the first time gap to obtain the second time gap.

Aspect 12: The method of any of Aspects 10-11, wherein the time domain spacing parameter indicates a scaling factor to be applied to the first time gap to obtain the second time gap.

Aspect 13: The method of any of Aspects 1-12, wherein the time domain spacing parameter indicates multiple time gaps, the method further comprising: receiving a control communication that indicates a time gap from the multiple time gaps, and wherein the respective time domain locations are based on the time gap.

Aspect 14: The method of any of Aspects 1-13, wherein the time domain spacing parameter indicates unequal time gaps that occur between pairs of DMRS instances included in the time domain resource allocation.

Aspect 15: The method of any of Aspects 1-14, wherein the time domain spacing parameter indicates a set of time intervals between first DMRS instances, and wherein the configuration indicates that one or more time intervals, from the set of time intervals, are to include one or more DMRS instances during the one or more time intervals.

Aspect 16: The method of Aspect 15, wherein the configuration indicates a quantity of DMRS instances to occur during respective time intervals of the one or more time intervals.

Aspect 17: The method of any of Aspects 1-16, wherein the time domain spacing parameter indicates a set of time gaps having unequal durations.

Aspect 18: The method of Aspect 17, wherein the configuration indicates quantities of pairs of DMRS instances for which respective time gaps, from the set of time gaps, are applicable.

Aspect 19: The method of any of Aspects 1-18, further comprising: transmitting capability information associated with the time domain spacing pattern information.

Aspect 20: The method of Aspect 19, wherein the capability information indicates at least one of: a DMRS processing window size, a buffer capacity, a quantity of DMRS symbols that can be processed during a DMRS processing window, a quantity of supported time domain bases for channel estimation, or a time domain filtering capability for DMRS-based channel estimation.

Aspect 21: The method of any of Aspects 1-20, wherein the time domain resource allocation spans multiple slots.

Aspect 22: A method of wireless communication performed by a network node, comprising: transmitting, for a user equipment (UE), a configuration indicating a time domain spacing pattern information for a demodulation reference signal (DMRS), the time domain spacing pattern information indicating a time domain spacing parameter and a time domain offset parameter; transmitting, for the UE, a start and length indicator value (SLIV) indicating a time domain resource allocation associated with a channel; and communicating, for the UE and during the time domain resource allocation, one or more DMRSs associated with the channel at respective time domain locations that are based at least in part on the SLIV and the time domain spacing pattern information.

Aspect 23: The method of Aspect 22, wherein the time domain spacing parameter indicates one or more time gaps between DMRS instances included in the time domain resource allocation.

Aspect 24: The method of any of Aspects 22-23, wherein the time domain spacing parameter indicates a uniform time gap that occurs between each DMRS instance included in the time domain resource allocation.

Aspect 25: The method of any of Aspects 22-24, wherein a value of the time domain spacing parameter indicates that the time domain resource allocation includes a single DMRS instance.

Aspect 26: The method of any of Aspects 22-25, wherein the time domain offset parameter indicates a starting time domain location of a first DMRS instance included in the time domain resource allocation.

Aspect 27: The method of Aspect 26, wherein the time domain offset parameter indicates a time offset relative to a start of the time domain resource allocation.

Aspect 28: The method of Aspect 26, wherein the time domain offset parameter indicates a time offset relative to a start of a first slot included in the time domain resource allocation.

Aspect 29: The method of any of Aspects 22-28, wherein the time domain spacing parameter indicates a time gap relative to a last DMRS symbol of a first DMRS instance and a first DMRS symbol of a second DMRS instance, wherein the first DMRS instance occurs earlier in time than the second DMRS instance.

Aspect 30: The method of any of Aspects 22-29, wherein the time domain spacing parameter indicates a time gap relative to first DMRS symbols of respective DMRS instances of a first DMRS instance and a second DMRS instance, wherein the first DMRS instance occurs earlier in time than the second DMRS instance.

Aspect 31: The method of any of Aspects 22-30, wherein the time domain spacing parameter indicates a first time gap, the method further comprising: transmitting a control communication that indicates a spacing offset parameter indicative of a second time gap that is associated with the first time gap, and wherein the respective time domain locations are based on the second time gap.

Aspect 32: The method of Aspect 31, wherein the spacing offset parameter indicates a value to be used to modify the first time gap to obtain the second time gap.

Aspect 33: The method of any of Aspects 31-32, wherein the time domain spacing parameter indicates a scaling factor to be applied to the first time gap to obtain the second time gap.

Aspect 34: The method of any of Aspects 22-33, wherein the time domain spacing parameter indicates multiple time gaps, the method further comprising: transmitting a control communication that indicates a time gap from the multiple time gaps, and wherein the respective time domain locations are based on the time gap.

Aspect 35: The method of any of Aspects 22-34, wherein the time domain spacing parameter indicates unequal time gaps that occur between pairs of DMRS instances included in the time domain resource allocation.

Aspect 36: The method of any of Aspects 22-35, wherein the time domain spacing parameter indicates a set of time intervals between first DMRS instances, and wherein the configuration indicates that one or more time intervals, from the set of time intervals, are to include one or more DMRS instances during the one or more time intervals.

Aspect 37: The method of Aspect 36, wherein the configuration indicates a quantity of DMRS instances to occur during respective time intervals of the one or more time intervals.

Aspect 38: The method of any of Aspects 22-37, wherein the time domain spacing parameter indicates a set of time gaps having unequal durations.

Aspect 39: The method of Aspect 38, wherein the configuration indicates quantities of DMRS instances for which respective time gaps, from the set of time gaps, are applicable.

Aspect 40: The method of any of Aspects 22-39, further comprising: receiving capability information associated with the time domain spacing pattern information.

Aspect 41: The method of Aspect 40, wherein the capability information indicates at least one of: a DMRS processing window size, a buffer capacity, a quantity of DMRS symbols that can be processed during a DMRS processing window, a quantity of supported time domain basis for channel estimation, or a time domain filtering capability for DMRS-based channel estimation.

Aspect 42: The method of any of Aspects 22-41, wherein the time domain resource allocation spans multiple slots.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a configuration indicating a time domain spacing pattern information for a demodulation reference signal (DMRS), the time domain spacing pattern information indicating a time domain spacing parameter and a time domain offset parameter;
receive a start and length indicator value (SLIV) indicating a time domain resource allocation associated with a channel; and
communicate, during the time domain resource allocation, one or more DMRSs associated with the channel at respective time domain locations that are based at least in part on the SLIV and the time domain spacing pattern information.

2. The UE of claim 1, wherein the time domain spacing parameter indicates one or more time gaps between DMRS instances included in the time domain resource allocation.

3. The UE of claim 1, wherein the time domain spacing parameter indicates a uniform time gap that occurs between each DMRS instance included in the time domain resource allocation.

4. The UE of claim 1, wherein a value of the time domain spacing parameter indicates that the time domain resource allocation includes a single DMRS instance.

5. The UE of claim 1, wherein the time domain offset parameter indicates a starting time domain location of a first DMRS instance included in the time domain resource allocation.

6. The UE of claim 5, wherein the time domain offset parameter indicates a time offset relative to a start of the time domain resource allocation.

7. The UE of claim 5, wherein the time domain offset parameter indicates a time offset relative to a start of a first slot included in the time domain resource allocation.

8. The UE of claim 1, wherein the time domain spacing parameter indicates a time gap relative to a last DMRS symbol of a first DMRS instance and a first DMRS symbol of a second DMRS instance, wherein the first DMRS instance occurs earlier in time than the second DMRS instance.

9. The UE of claim 1, wherein the time domain spacing parameter indicates a time gap relative to first DMRS symbols of respective DMRS instances of a first DMRS instance and a second DMRS instance, wherein the first DMRS instance occurs earlier in time than the second DMRS instance.

10. The UE of claim 1, wherein the time domain spacing parameter indicates a first time gap, wherein the one or more processors are configured to cause the UE to:
receive a control communication that indicates a spacing offset parameter indicative of a second time gap that is associated with the first time gap, and wherein the respective time domain locations are based on the second time gap.

11. The UE of claim 10, wherein the spacing offset parameter indicates a value to be used to modify the first time gap to obtain the second time gap.

12. The UE of claim 10, wherein the time domain spacing parameter indicates a scaling factor to be applied to the first time gap to obtain the second time gap.

13. The UE of claim 1, wherein the time domain spacing parameter indicates multiple time gaps, wherein the one or more processors are configured to cause the UE to:
receive a control communication that indicates a time gap from the multiple time gaps, and wherein the respective time domain locations are based on the time gap.

14. The UE of claim 1, wherein the time domain spacing parameter indicates unequal time gaps that occur between pairs of DMRS instances included in the time domain resource allocation.

15. A network node for wireless communication, comprising:
one or more memories; and
one or more processors, coupled to the one or more memories, configured to cause the network node to:
transmit, for a user equipment (UE), a configuration indicating a time domain spacing pattern information for a demodulation reference signal (DMRS), the time domain spacing pattern information indicating a time domain spacing parameter and a time domain offset parameter;
transmit, for the UE, a start and length indicator value (SLIV) indicating a time domain resource allocation associated with a channel; and
communicate, for the UE and during the time domain resource allocation, one or more DMRSs associated with the channel at respective time domain locations that are based at least in part on the SLIV and the time domain spacing pattern information.

16. The network node of claim 15, wherein the time domain spacing parameter indicates one or more time gaps between DMRS instances included in the time domain resource allocation.

17. The network node of claim 15, wherein the time domain spacing parameter indicates a uniform time gap that occurs between each DMRS instance included in the time domain resource allocation.

18. The network node of claim 15, wherein a value of the time domain spacing parameter indicates that the time domain resource allocation includes a single DMRS instance.

19. The network node of claim 15, wherein the time domain offset parameter indicates a starting time domain location of a first DMRS instance included in the time domain resource allocation.

20. The network node of claim 19, wherein the time domain offset parameter indicates a time offset relative to a start of the time domain resource allocation.

21. The network node of claim 19, wherein the time domain offset parameter indicates a time offset relative to a start of a first slot included in the time domain resource allocation.

22. A method of wireless communication performed by a user equipment (UE), comprising:
receiving a configuration indicating a time domain spacing pattern information for a demodulation reference signal (DMRS), the time domain spacing pattern information indicating a time domain spacing parameter and a time domain offset parameter;
receiving a start and length indicator value (SLIV) indicating a time domain resource allocation associated with a channel; and
communicating, during the time domain resource allocation, one or more DMRSs associated with the channel at respective time domain locations that are based at least in part on the SLIV and the time domain spacing pattern information.

23. The method of claim 22, wherein the time domain spacing parameter indicates a set of time intervals between first DMRS instances, and wherein the configuration indicates that one or more time intervals, from the set of time intervals, are to include one or more DMRS instances during the one or more time intervals.

24. The method of claim 23, wherein the configuration indicates a quantity of DMRS instances to occur during respective time intervals of the one or more time intervals.

25. The method of claim 22, wherein the time domain spacing parameter indicates a set of time gaps having unequal durations.

26. The method of claim 25, wherein the configuration indicates quantities of pairs of DMRS instances for which respective time gaps, from the set of time gaps, are applicable.

27. The method of claim 22, further comprising:
transmitting capability information associated with the time domain spacing pattern information.

28. The method of claim 27, wherein the capability information indicates at least one of:
a DMRS processing window size,
a buffer capacity,
a quantity of DMRS symbols that can be processed during a DMRS processing window,
a quantity of supported time domain bases for channel estimation, or
a time domain filtering capability for DMRS-based channel estimation.

29. The method of claim 22, wherein the time domain resource allocation spans multiple slots.

30. A method of wireless communication performed by a network node, comprising:
transmitting, for a user equipment (UE), a configuration indicating a time domain spacing pattern information for a demodulation reference signal (DMRS), the time domain spacing pattern information indicating a time domain spacing parameter and a time domain offset parameter;
transmitting, for the UE, a start and length indicator value (SLIV) indicating a time domain resource allocation associated with a channel; and
communicating, for the UE and during the time domain resource allocation, one or more DMRSs associated with the channel at respective time domain locations that are based at least in part on the SLIV and the time domain spacing pattern information.
